(19) United States
(12) Patent Application Publication
(10) Pub. No.: US 2010/0077417 A1
(43) Pub. Date: Mar. 25, 2010

(54) Optical Disk Drive Capable of Inhibiting Vibration of Optical Disk

(75) Inventors: Wen-Hong Wang, Hsinchu (TW); Cheng-Ho Tien, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: PHILIPS & LITE-ON DIGITAL SOLUTIONS CORPORATION, Taipei City (TW)

(21) Appl. No.: 12/357,517

(22) Filed: Jan. 22, 2009

(30) Foreign Application Priority Data
Sep. 24, 2008 (CN) 200810161048.5

(51) Int. Cl. G11B 17/04

(52) U.S. Cl. 720/611

(57) ABSTRACT

An optical disk drive is disclosed. The distance between the surface of the optical disk and the inner upper surface of the optical disk drive is less than 3.5 mm while performing the data reading or writing procedures on the optical disk loaded in the optical disk drive.

### FIELD OF THE INVENTION

The present invention relates to an optical disk drive, and more particularly to an optical disk drive capable of inhibiting the vibration phenomenon of the optical disk in high-speed rotation effectively by improving airflow field inside the optical disk drive.

### BACKGROUND OF THE INVENTION

The advance of electronic-mechanical related technologies consequently results in swift improvement in the peripheral accessories, such as hard disk drives, optical disk drives, scanning machines, and printing machines. As for the optical disk drive, a commercial optical disk is an inevitable storage medium at present since it is cheap and capable of storing up to several GBs of music or image data for a long time. The BD (Blu-ray Disc) of the new generation even has a storage capacity of several tens of GBs such that the optical disk drive plays an even more important role in data storage.

Please refer to FIG. 1, which shows an interrelated structure of an optical disk drive, wherein the optical disk drive 1 mainly comprises a chassis 10, a traverse module 11, a tray 12, an upper cover 13, and a faceplate 14. As shown in the figure, the traverse module 11 is mounted in the chassis 10 for rotating the optical disk and performing the data reading or writing procedures on the optical disk. The tray 12 is also mounted in the chassis 10, and located above the traverse module 11 for supporting the optical disk. The upper cover 13 is mounted above the chassis 10 for shielding and protecting the traverse module 11 and the tray 12. The faceplate 14 is mounted on the front end of the chassis 10, wherein the faceplate 14 has a rectangular opening 140 to allow the tray 12 to move into or out of the chassis 10 via the opening 140 and to thereby enable the user to put in or take out the optical disk.

The traverse module 11 mainly comprises a spindle motor 110 and a turntable 111 mounted on the spindle motor 110 for rotating the optical disk loaded on the tray 12. In addition, a reading head 112 is mounted on a slide base 113, and it is driven by a sled motor 114 to move reciprocally along a guide rod 115 so that the reading head 112 is horizontally movable along the surface of the optical disk. In addition, a voice coil motor is also mounted on the slide base for adjusting the vertical position of the reading head 112 so as to enable the laser light to be focused on the optical disk precisely for reading/writing the data on the optical disk.

As the storage capacity of the optical disk increases, the disk of new generation should have higher reading/writing speed in order to shorten the reading/writing time for the data. Presently, the rotation speed of the DVD (Digital Versatile Disc) available in the market is raised from 16× speed to 20× speed, 22× speed, or even 24 × speed. For instance, the optical disk of the 20× DVD rotates 12,000 rpm, and the optical disk of the 24× DVD even rotates 14,000 rpm.

It is worthy to note that the problem of vibration that occurs on the optical disk becomes more seriously as the reading/writing speed of the optical disk drive increases persistently. Especially, when the rotation speed of the optical disk exceeds 10,000 rpm, the unstable vibration will take place, and the phenomenon of vibration dispersion will occurs gradually. In this situation, in addition to the increase of the breakup probability of the optical disk, the excessive violent vibration will make the reading head 112 hard to read or write data stably. Moreover, when the rotation speed of the optical disk exceeds 12,000 rpm, the air pressure difference (above the upper surface of the disk and below the lower surface of the disk) will lift up the rotating disk, which causes the unbalanced rotating disk. Under such a condition, it becomes an urgent task for the manufacturers to solve the problem how to lower the unstable vibration of the optical disk in the high-speed optical disk drive.

### SUMMARY OF THE INVENTION

The present invention provides an optical disk drive, wherein the distance between the surface of the optical disk and the inner upper surface of the optical disk drive is less than 3.5 mm while performing the data reading or writing procedures on the optical disk loaded in the optical disk drive. In the preferred embodiment, the surface of the optical disk is divided into an outer ring region and an inner ring region, and the distance between the inner upper surface of the optical disk drive and any point within the outer ring region is less than 3.5 mm.

The aforesaid optical disk drive comprises a chassis, a tray disposed on the chassis for supporting the optical disk, and an upper cover mounted on the chassis for covering the tray and the optical disk.

In a first preferred embodiment, the upper cover has a lower surface on which a rib that extends downward is formed, and the distance between the surface of the rib and the surface of the optical disk is less than 3.5 mm. In addition, the rib is a circular rib, wherein the circular rib will cover the outer ring region of the optical disk completely when the optical disk is loaded into the optical disk drive. In other embodiments, the rib can include a circular rib and an extended rib extended from the circular rib and the extended rib is positioned above the outer ring region. The rib can be a cone-shaped rib.

In a second preferred embodiment, the optical disk drive further comprises a covering plate mounted on the chassis and located above the tray, wherein the distance between the lower surface of the covering plate and the surface of the optical disk is less than 3.5 mm. Similarly, the covering plate will cover the outer ring region of the optical disk completely when the optical disk is loaded into the optical disk drive.

In the preferred embodiments, the covering plate is made of metal or plastic material. In addition, the covering plate and the chassis are integrally formed.

### BRIEF DESCRIPTION OF THE DRAWINGS

FIG. 1 shows an interrelated structure of an optical disk drive;

FIGS. 2 and 3 show the distribution of air pressure on the upper surface of the optical disk in high speed rotation under different situations;

FIG. 4 shows that the surface of the optical disk is divided into an outer ring region and an inner ring region;

FIG. 5 shows a rib that extends downward from the surface of the upper cover in accordance with a first preferred embodiment of the present invention;

FIG. 6 shows a partial cross-sectional view of the optical disk drive in accordance with the first preferred embodiment of the present invention;

FIG. 7 shows a circular rib and an extended rib of the upper cover;

FIG. 8 shows the distribution of air pressure on the upper surface of the optical disk in high speed rotation of FIG. 7;

FIG. 9 shows a circular rib and a cone-shaped rib of the upper cover;

FIG. 10 shows that a covering plate is mounted on the chassis in accordance with a second preferred embodiment of the present invention;

FIG. 11 shows a partial cross-sectional view of the optical disk drive in accordance with the first preferred embodiment of the present invention;

FIG. 12 shows that the covering plate is integrally formed on the chassis directly; and

FIG. 13 shows a partial cross-sectional view of the optical disk drive.

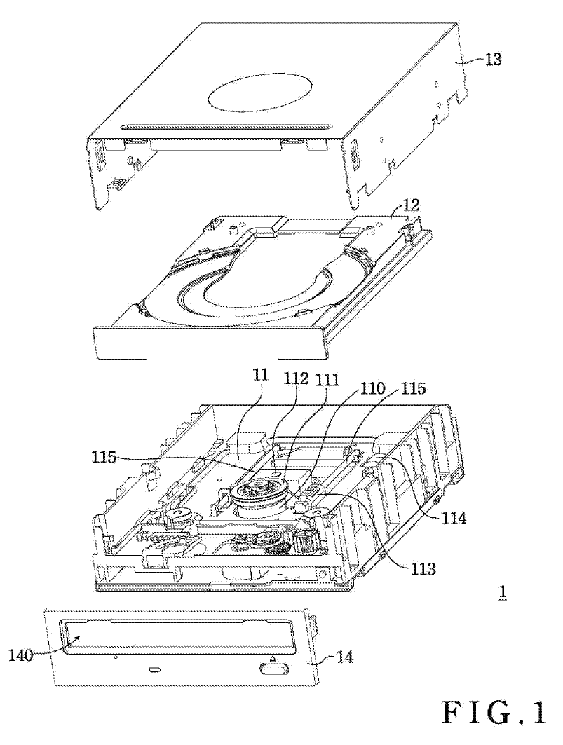

### DESCRIPTION OF THE PREFERRED EMBODIMENT

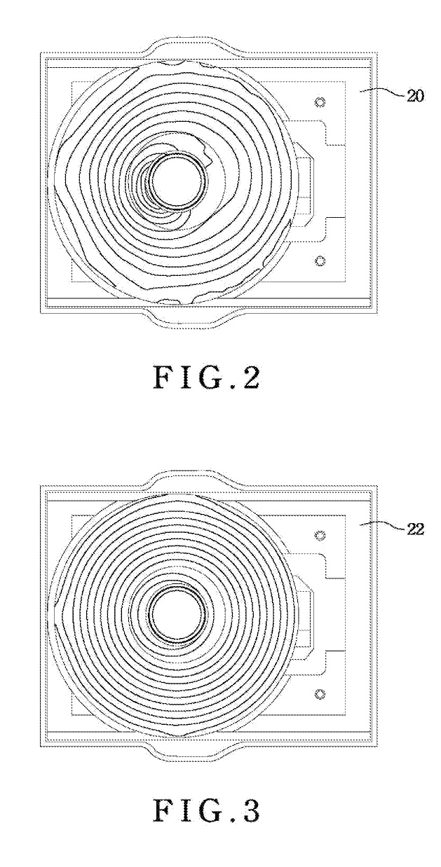

Please refer to FIGS. 2 and 3, these two figures show the distribution of air pressure on the upper surface of the optical disk in high-speed rotation. These figures are viewed from the top of optical disk drive. In addition, in the optical disk drive 20 shown in FIG. 2 and the optical disk drive 22 shown in FIG. 3, the distances between the optical disks and the upper covers are different from each other. In FIG. 2, the distance between the optical disk and the upper cover of the optical disk drive 20 is 7.0 mm. In FIG. 3, the distance between the optical disk and the upper cover of the optical disk drive 22 is 3.5 mm. As can be apparently seen from these two figures, when there exists a larger distance such as 7.0 mm shown in FIG. 2 between the optical disk and the upper cover, the isobaric distribution of the air pressure on the upper surface of the optical disk is in an extremely mess. In such a condition, the airflow on the surface of the optical disk is very unstable, causing considerable vibration of the optical disk. Further by comparison, when the distance between the optical disk and the upper cover is reduced to 3.5 mm shown in FIG. 3, the airflow on the surface of the optical disk is very stable such that the isobaric distribution of the air pressure is much more orderly.

In order to inhibit the occurrence of the violet vibration during the high-speed rotation of the optical disk, the present invention provides an optical disk drive with improved inner space to make sure that the distance between the surface of the optical disk and the inner upper surface of the optical disk drive will be less than 3.5 mm while performing data reading or writing procedures on the optical disk disposed inside the optical disk drive.

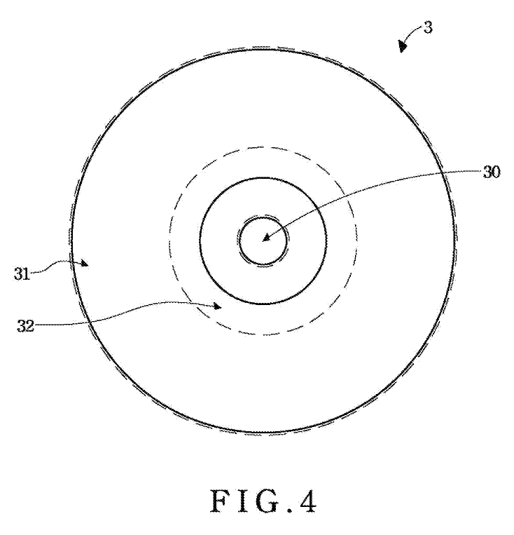

As shown in FIG. 4, a general optical disk 3 has a round hole 30 on the center so as to allow a turntable 111 of a traverse module 11 to support the optical disk 3 via the round hole 30 for rotating the optical disk 3 by driving of the spindle motor 110 after putting the optical disk 3 inside the optical disk drive. It is worthy to note that the surface of the optical disk 3 can be divided into an outer ring region 31 and an inner ring region 32 based upon their respective distance from the round hole 30. The inner edge of the inner ring region 32 is the round hole 30 and the outer edge of the outer ring region 31 is the outer rim of the optical disk 3. The inner ring region 32 does not contain user data area. In the preferred embodiment of the present invention, in order to inhibit the occurrence of vibration of the optical disk more effectively, the distance between the inner upper surface of the optical disk drive and any point on the surface of the outer ring region 31 is certainly less than 3.5 mm.

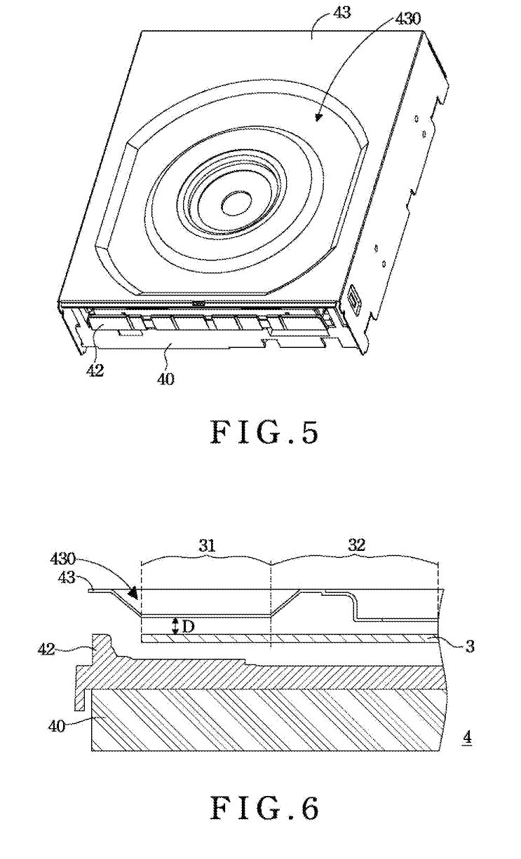

Please refer to FIG. 5 and FIG. 6, which show the design to make the distance between the optical disk and the optical disk drive less than 3.5 mm in accordance with a first preferred embodiment of the present invention. As described above, the optical disk drive 4 mainly comprises a chassis 40, a tray 42, and an upper cover 43. The tray 42 is disposed on the chassis 40 for supporting the optical disk 3. The upper cover 43 is mounted on the chassis 40 for covering the tray 42 and the optical disk 3. As shown in FIG. 5, a rib 430 that extends downward is formed on the lower surface of the upper cover 43. The rib 430 can be manufactured by machine to be formed by pressing the upper surface of the upper cover 43 directly. In the first preferred embodiment, the rib 430 is a circular rib such that the circular rib 430 can cover the outer ring region 31 of the optical disk 3 completely when the optical disk 3 is loaded into the optical disk drive 4 by the tray 42.

Please refer to FIG. 6, a partial cross-sectional view of the optical disk drive 4 is shown. When the optical disk 3 is loaded on the tray 42 and the tray 42 is moved into the optical disk drive 4 for the purpose of performing reading and writing procedures, the distance D between the surface of the rib 430 formed on the lower surface of the upper cover 43 and the surface of the optical disk 3 will be less than 3.5 mm. Moreover, as described above, the rib 430 is a circular structure. Therefore, the outer ring region 31 of the optical disk 3 can be completely covered by the circular rib 430 as viewed downward from the top of the optical disk drive 4. In other words, the distance between any point within the outer ring region 31 of the optical disk 3 and the lower surface of the rib 430 will be less than 3.5 mm.

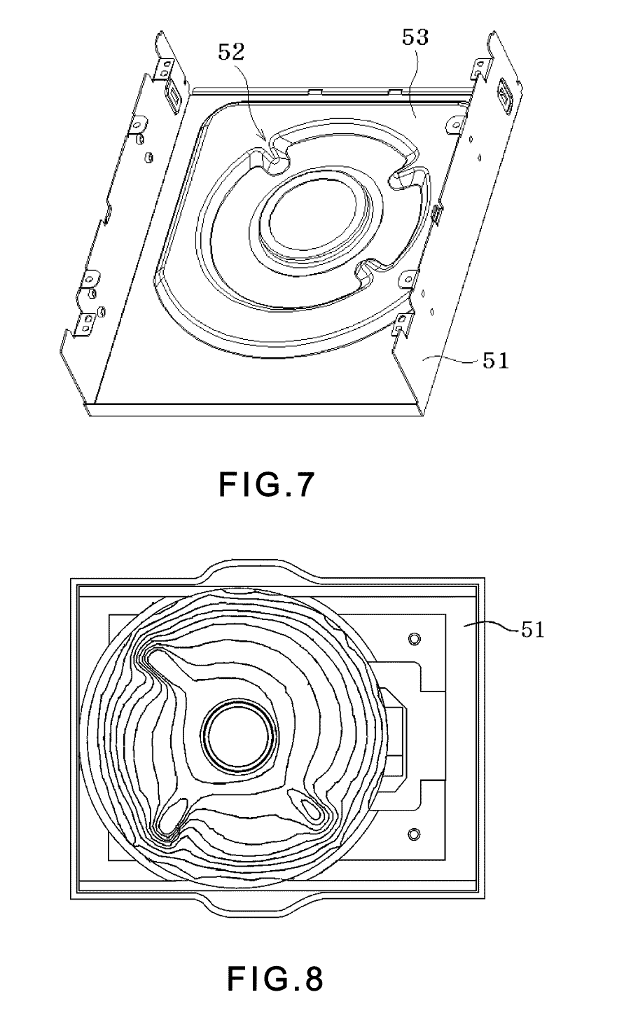

Referring to FIG. 7 and FIG. 8, FIGS. 7 and 8 show the rib design and the air flow of different embodiment. In FIG. 7, the upper cover 51 includes a circular rib 53 and three extended ribs 52 extended from the circular rib 53. The extended rib 52 is extended and positioned above the outer ring region 31 of the disk 3 to stable the air pressure of the upper surface of the rotating disk. FIG. 8 shows the distribution of air pressure on the upper surface of the optical disk in high speed rotation of FIG. 7. Comparing FIG. 8 and FIG. 2, the extended rib 52 and circular rib 53 stabilize the air pressure and the isobaric distribution of the air pressure is much more orderly. Therefore, when the disk is rotating at high speed (12,000 rpm), the disk is not lifted up due to the pressure difference between the upper surface and lower surface of the disk. In this embodiment, preferably, the nearest distance between the extended rib 52 and the center of the disk is within radius of 40 mm of the disk.

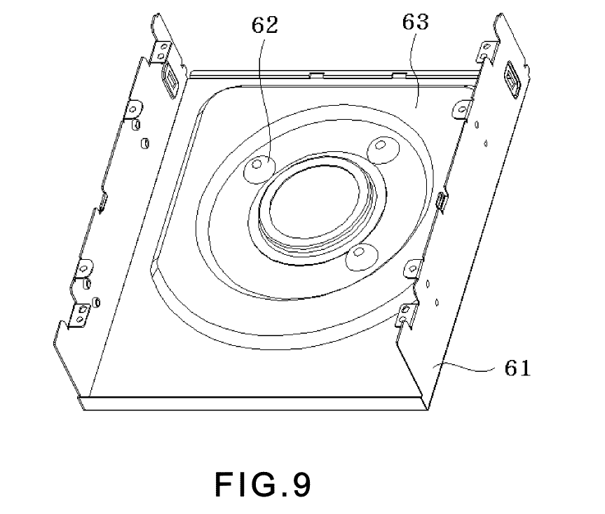

Referring to FIG. 9, FIG. 9 shows a circular rib and a cone-shaped rib of the upper cover. In this embodiment, the upper cover 61 includes a circular rib 63 and three cone-shaped ribs 62. The distance between the cone-shaped rib 62 and the center of the disk is preferably within radius of 40 mm of the disk.

Although FIGS. 5, 7 and 9 show different designs of the rib of the invention, people skilled in the art can vary the size, position and numbers of the rib to meet their needs. For example, a plurality of ribs can be arranged circularly or in arch-shaped.

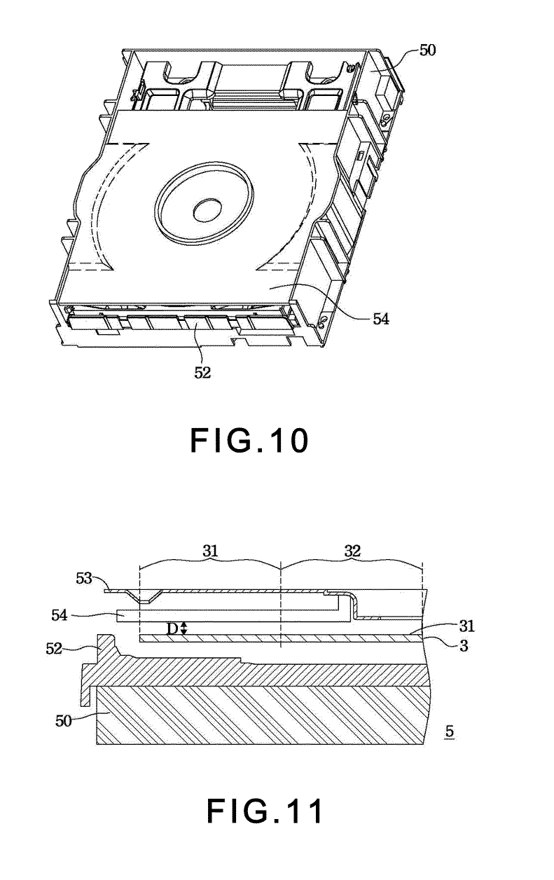

Please refer to FIG. 10 and FIG. 11, these figures show a second preferred embodiment of the present invention. FIG. 10 and FIG. 11 disclose a structural design to make the distance between the optical disk and the inner upper surface of the optical disk drive less than 3.5 mm. As described above, an optical disk drive 5 mainly comprises a chassis 50, a tray 52, and an upper cover 53. The tray 52 is disposed on the chassis 50 for supporting the optical disk 3. The upper cover 53 is mounted on the chassis 50 for covering the tray 52 and the optical disk 3. It is worthy to note that the optical disk drive 5 further comprises a covering plate 54 mounted on the chassis 50 above the tray 52. As shown in the figures, the covering plate 54 is a roughly rectangular plate and mounted on the chassis 50 to form a containing space between the covering plate 54 and the chassis 50. When the tray 52 is moved into the optical disk drive 5, the containing space can contain the tray 52 and the covering plate 54 can cover the outer ring region 31 of the optical disk 3 completely.

Please refer to FIG. 11, a partial cross-sectional view of the optical disk drive 5 is shown. When the optical disk 3 is loaded on the tray 52 and the tray 52 is moved into the optical disk drive 5 for the purpose of performing reading and writing procedures, the distance D between the lower surface of the covering plate 54 and the surface of the optical disk 3 will be less than 3.5 mm. In addition, the outer ring region 31 of the optical disk 3 can be completely covered by the covering plate 54 as viewed downward from the top of the optical disk drive 5. In other words, the distance D between any point within the outer ring region 31 of the optical disk 3 and the lower surface of the covering plate 54 will be less than 3.5 mm.

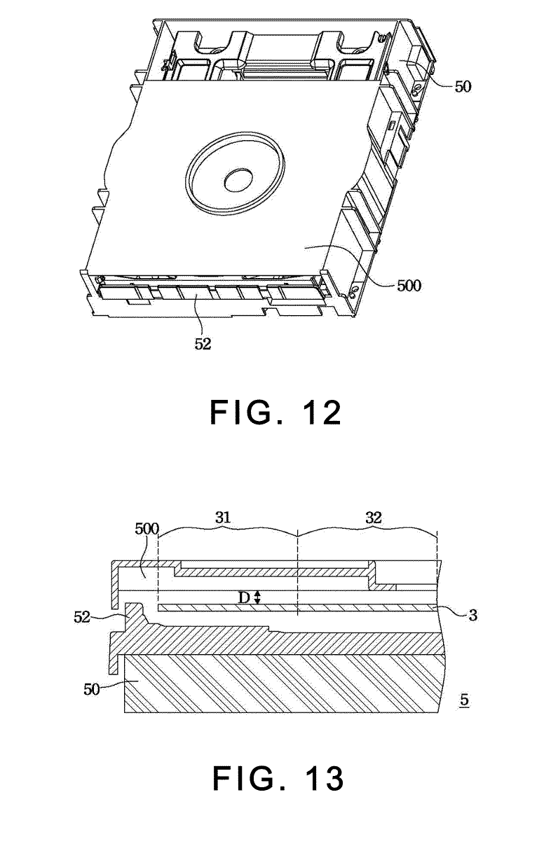

In the preferred embodiment, the covering plate 54 can be made of metal or plastic material. Besides, the covering plate 54 and the chassis 50 can be integrally manufactured. In other words, the covering plate 54 can be formed on the chassis 50 directly while manufacturing the chassis 50 by using the mold. Please refer to FIG. 12, this figure shows that the covering plate 500 that connects to the chassis 50 is integrally formed during the same step of manufacturing the chassis 50. FIG. 13 shows a partial cross-sectional view of the optical disk drive. Similarly, when the optical disk 3 is loaded on the tray 52 and the tray 52 is moved into the optical disk drive, the outer ring region 31 of the optical disk 3 can be exactly completely covered by the covering plate 500 and the distance D between any point on the outer ring region 31 of the optical disk 3 and the lower surface of the covering plate 500 will be less than 3.5 mm.

The present invention has considerable advantages. By forming the rib that extends downward or forming the covering plate between the tray and the upper cover, the distance between the optical disk and the inner upper surface of the optical disk drive can be reduced effectively to a value less than 3.5 mm. As a result, when the optical disk rotates at 10,000 rpm, the airflow disturbance, which occurs during the high-speed rotation of the optical disk, can be reduced effectively since the space formed above the optical disk is reduced. In other words, because the airflow on the optical disk is relatively stable, the distribution of the air pressure will be very uniform and stable, resulting in that the vibration phenomenon of the optical disk can be improved effectively. As a result, the vibration magnitude of the optical disk is relatively small while performing the data reading or writing procedures on the optical disk in high-speed rotation. Consequently, the accuracy and the efficiency of the reading head that performs the reading or writing programs can be significantly increased.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. An optical disk drive having a distance between a surface of an optical disk and an inner upper surface of the optical disk drive, and the distance being less than 3.5 mm while performing data reading or writing procedures on the optical disk loaded in the optical disk drive.

2. The optical disk drive of claim 1, wherein the surface of the optical disk is divided into an outer ring region and an inner ring region, and a distance between the inner upper surface of the optical disk drive and any point of the outer ring region is less than 3.5 mm.

3. The optical disk drive of claim 1, further comprising:
a chassis;
a tray, disposed on the chassis for supporting the optical disk; and
an upper cover, mounted on the chassis for covering the tray and the optical disk.

4. The optical disk drive of claim 3, wherein the upper cover has a lower surface on which a rib that extends downward is formed, and a distance between a surface of the rib and the surface of the optical disk is less than 3.5 mm.

5. The optical disk drive of claim 4, wherein the rib is a circular rib and the surface of the optical disk is divided into an outer ring region and an inner ring region, and wherein the outer ring region of the optical disk is covered by the circular rib completely.

6. The optical disk drive of claim 3, further comprising a covering plate mounted on the chassis and located above the tray, wherein a distance between a lower surface of the covering plate and the surface of the optical disk is less than 3.5 mm.

7. The optical disk drive of claim 6, wherein the surface of the optical disk is divided into an outer ring region and an inner ring region, and the outer ring region of the optical disk is covered by the covering plate completely.

8. The optical disk drive of claim 6, wherein the covering plate is made of metal.

9. The optical disk drive of claim 6, wherein the covering plate is made of plastic material.

10. The optical disk drive of claim 6, wherein the covering plate and the chassis are integrally formed.

11. The optical disk drive of claim 4, wherein the optical disk drive includes a plurality of ribs and the ribs are arranged circularly or arch-shaped.

12. The optical disk drive of claim 4, wherein the rib is a cone-shaped rib.

13. The optical disk drive of claim 4, wherein the rib includes a circular rib and an extended rib extended from the circular rib and the optical disk is divided into an outer ring region and an inner ring region, and wherein the extended rib is positioned above the outer ring region.

14. The optical disk drive of claim 4, wherein the rib is positioned within the radius of 40 mm of the disk.
